(19) United States
(12) Patent Application Publication
(10) Pub. No.: US 2014/0344007 A1
(43) Pub. Date: Nov. 20, 2014

(54) PLANT OPERATING POINT DETERMINATION BY INTEGRATING PROFIT PROFILE AND RISK PROFILE

(71) Applicant: HONEYWELL INTERNATIONAL INC., MORRISTOWN, NJ (US)

(72) Inventors: MAYANK SHENDE, BHANDARA, MAHARASHTRA (IN); RANGANATHAN SRINIVASAN, BANGALORE KARNATAKA (IN); ANDREW JOHN TRENCHARD, ROMSEY, HAMPSHIRE (UK); ANDREW OGDEN-SWIFT, BISHOPS WALTHAM, HANTS (UK)

(73) Assignee: HONEYWELL INTERNATIONAL INC., MORRISTOWN, NJ (US)

(21) Appl. No.: 13/897,639

(22) Filed: May 20, 2013

(51) Int. Cl. G06Q 10/06

(52) U.S. Cl. CPC G06Q 10/0633
USPC 705/7.27

(57) ABSTRACT

A method for controlling physical processes includes providing a process model for a physical process run by a processing plant, where the process model represents an interaction between a plurality of controlled process variables and provides a variability measure for at least a portion of the controlled process variables. The process model is used with software run on a computing device to simulate an updated operating point including an updated value or updated range for at least one selected controlled process variable, where the simulation generates a future risk profile and future profit profile for the selected controlled process variable. Risk/profit profile information is generated for the selected controlled process variable from the future risk profile together with information from the future profit profile into at least one of a combined text, numeric, and graphical representation which includes an alarm limit for the selected controlled process variable.

### FIELD

Disclosed embodiments relate to feedback control systems, more specifically to methods and systems for process control of physical processes run at manufacturing plants including risk assessment.

### BACKGROUND

Processing facilities which operate physical processes that process materials, such as manufacturing plants, chemical plants and oil refineries, are typically managed using process control systems. Valves, pumps, motors, heating/cooling devices, and other industrial equipment typically perform actions needed to process the materials in the processing facilities. Among other functions, the process control systems often manage the use of the industrial equipment in the processing facilities.

In conventional process control systems, controllers are often used to control the operation of the industrial equipment in the processing facilities. The controllers can monitor the operation of the industrial equipment, provide control signals to the industrial equipment, and/or generate alarms when malfunctions are detected. Process control systems typically include one or more process controllers and input/output (I/O) devices communicatively coupled to at least one workstation and to one or more field devices, such as through analog and/or digital buses. The field devices can include sensors (e.g., temperature, pressure and flow rate sensors), as well as other passive and/or active devices. The process controllers can receive process information, such as field measurements made by the field devices, in order to implement a control routine. Control signals can then be generated and sent to the industrial equipment to control the operation of the process.

An industrial plant generally has a control room with displays for displaying process parameters such as key temperatures, pressures, fluid flow rates and flow levels, operating positions of key valves, pumps and other equipment, etc. Operators in the control room can control various aspects of the plant operation, typically including overriding automatic control. Generally in a plant operation scenario, the operator desires operating conditions such that the plant always operates at its “optimal” operating point (i.e. where the profit associated with the process is at a maximum, which can correspond to the amount of product generated) and thus close to the alarm limits. Based on changing of the feedstock composition for a chemical process, changing products requirements or economics, or other changes in constraints, the operating conditions may be changed to increase profit. However, there is an increased risk associated with operating the plant closer to the alarm limits due to variability in the process.

Advanced controllers often use model-based control techniques to control the operation of the industrial equipment. Model-based control techniques typically involve using an empirically derived process model (i.e. based on historical process data) to analyze current input (e.g., sensor) data received, where the model identifies how the industrial equipment should be controlled and thus operated based on the input data received.

In order to enhance process safety in the plant or refinery commercially available risk assessment tools such as alarm manager (AM) and early event detection (EED) can be used to address hazard identification and risk assessment problems for industries including chemical process industries. In risk assessment, there are several methods which utilize accident precursor data or near-misses data using large alarm databases to predict the occurrence of accidents in the future. In one work, a dynamic risk analysis method tracks abnormal events using event tree mapping and set theoretic formulation, and then calculates the likelihood of the events and the failure probabilities using Bayesian theory.

Commercially available tools can assist operators to smooth the operation of processes run by plants by including specialized process assessment using separate economic assessment tools and risk assessment tools. FIG. 1A shows a general example of a normalized profit profile, where X and Xₗᵢₘᵢₜ together define the operating limit range of the process. As one moves closer to the upper operating limit Xₗᵢₘᵢₜ the profit is seen to increase, but as one crosses (exceeds) Xₗᵢₘᵢₜ the profit obtained from the process becomes zero (zero profit).

FIG. 1B shows a general example of a normalized risk profile, where the risk index is evaluated with respect to time over a 24 hour period. A risk index value close to one (1) means the process is safe (excellent safety), and a risk index value lower than 0.8 as shown means the process risk is extremely high and thus the process is highly unsafe. One can also analyze the risk profile by averaging over a period of time, such as evaluating daily or hourly averages of the risk index.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize that although there are commercially available tools that can aid a user (e.g., a process operator, technician or engineer, hereafter an “operator”) at processing facilities which operate physical processes (i.e., which operate on tangible materials, such as a manufacturing plant) to enhance process safety by reducing process risk, and other separate tools that can help increase profit, these respective tools act independently and do not interact with each other. An unmet need is thus a method and system that provide operators sufficient information to decide how close or how far to select operating points for process variables relative to their respective alarm limits to allow raising the profit while still providing sufficient reliability (e.g., minimize process operation above the respective alarm limits).

Disclosed methods provide for this unmet need by providing a software algorithm providing integration of a profit assessment and a risk assessment allowing their interaction to be visualized together in a display, which permits operators to select operating points for the process that increase profit and maintain sufficient reliability. By simultaneously representing the risk profile and profit profile together for a new proposed (future) operating point along with the alarm limit(s), an operator can identify a trade-off between risk and profit that allows pushing the operating point closer to the alarm limit(s) compared to commercially available separate tools to provide higher profit while still maintaining sufficient reliability for the process.

### BRIEF DESCRIPTION OF THE DRAWINGS

FIG. 1A shows a general example of a normalized profit profile.

FIG. 1B shows a general example of a normalized risk profile as a function of time.

FIG. 2 is a flow chart that shows steps in a method of controlling physical processes including integrating a future risk profile together with a future profit profile together to help an operator determine a new operating point for the process, according to an example embodiment.

FIG. 3 is a schematic representation of the flow of an example method of controlling physical processes including integrating a future risk profile together with a future profit profile to help an operator determine a new operating point further defining an example of the simulating step in the method described relative to FIG. 2.

FIG. 4 is a graphical plot of the value of a process variable (y axis) vs. time (x-axis) showing a current operating point and a new operating point for a process variable including the simultaneous representation of a risk profile together with a profit profile along with an alarm limit to help an operator determine a new operating point, according to an example embodiment.

FIG. 5A shows an example flow for an offline integrated profit assessment and risk assessment tool embodiment, where various operating points can be simulated using a process model to predict variable dynamics and alarm violation events, according to an example embodiment.

FIG. 5B shows an example flow for an online integrated profit assessment and risk assessment tool embodiment, where an operator performs a “what if analysis” for a proposed operating point change (new operating point) by estimating the risk and profit associated with a desired operating point change, and then makes a decision on the targeted operating point by a trade-off between risk and profitability, according to an example embodiment.

FIG. 6 is a depiction of an example fired heater in a chemical processing plant or a crude oil refinery along with its associated inputs and outputs upon which the Example section provided below is based.

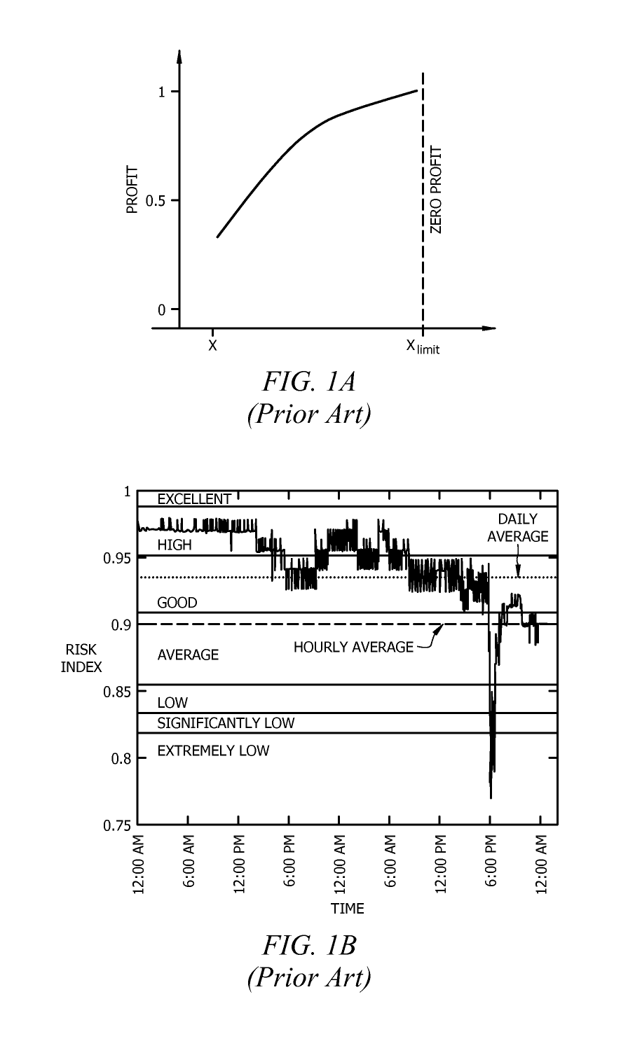

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

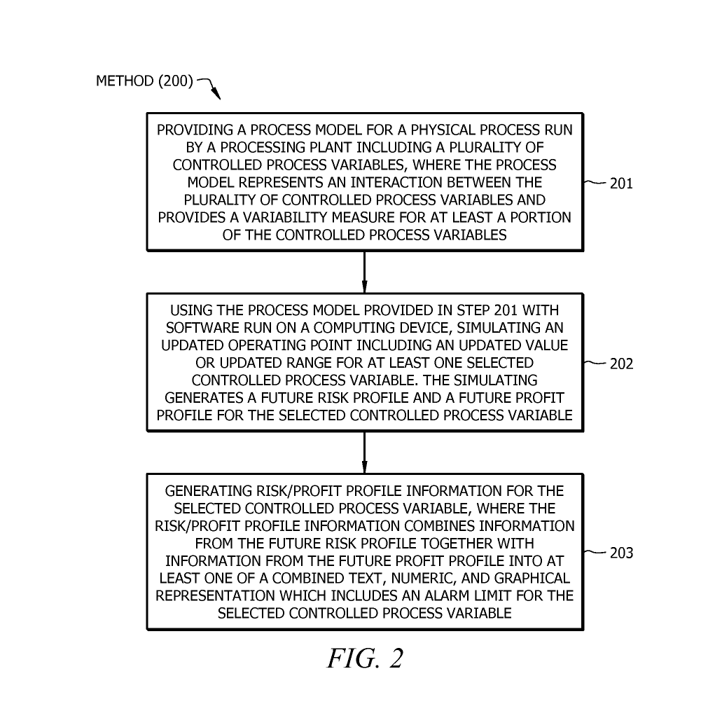

FIG. 2 is a flow chart that shows steps in an example method 200 of controlling physical processes including integrating a future (i.e., new or proposed) risk profile together with a future profit profile along with an alarm limit for a physical process to help an operator determine a new operating point to be used, according to an example embodiment. Step 201 comprises providing a process model for a physical process run by a processing plant that runs a physical process including a plurality of controlled process variables. The process model generally includes a steady state and dynamic model.

The process model represents an interaction between the plurality of controlled process variables and provides a variability measure for at least a portion of the controlled process variables. For typical large-scale industrial processes, typically 150 to 400 variables are monitored; however, only a small percentage (e.g., less than 10%) of these variables are selected as primary (or key) variables, where primary variables are selected during the design and commissioning of plants by carrying-out analyses of tradeoffs between the safety (reflected in the risk) and profitability of the plant. For example, principal-component analyses can be used to identify primary variables systematically that should be monitored along with individual process variables to improve the tracking of process dynamics. The process model is generally derived at least in part by stored historical plant data.

Commercially available tools including control performance monitoring (CPM) and system identification can be used to estimate the variability of respective process variables and a model of the physical process. The process upsets abnormal (non-random) variability, as contrasted with normal (random) variability, should generally be excluded from the historical database provided to the model.

As used herein, “variability” refers to the noise of the process measurements of the respective process variables, which also have associated alarms/alarm limits. The term variability in an ideal control scenario would include only “noise” in the respective process variables, however, in real life situations variability includes external process disturbances, problems with equipment such as sticking valves, weather variations, poor controller tuning or changes in the operating regime. Alarm limits are generally set by an off-line engineering work process that estimates the risk to process safety, environmental release and equipment damage and takes into account the operators' response time to respond to the process excursion. In actual practice, operators may be permitted to override some alarms on a temporary basis due to operational changes or short term needs.

The variability for a process variable can be described in terms of a standard deviation (σ), or more accurately by a distribution of variation magnitude vs. frequency of occurrence of the magnitude. The variability measure is generally derived from stored historical data from the process. Generating a fundamental model that calculates the variability of process variables is known in the art. The process model can be a data regressed model. The process model can also be based on a first principle model (i.e., a physics model that seeks to calculate a physical quantity starting directly from established laws of physics) that is calibrated to historical process data. The model can be parameterized/non-parameterized, linear/non-linear or be a first principle model. The process model is generally a Multiple Input, Multiple Output (MIMO) model.

A noise corrupted linear system can be described by the following equation:

ŷ=Gu+He

where y is the system output and u is the input, while e denotes the unmeasured (white) noise source. G is the system's transfer function and H provides a description of the noise disturbance. There are many ways to estimate G and H. Essentially they each correspond to different ways of parameterizing these functions. Another system representation includes auto-regressive terms: i.e.

ŷ=Ay+Bu+He

Step 202 comprises using the process model provided in step 201 with software run on a computing device (i.e., having a processor such as microprocessor and associated memory), simulating an updated operating point (new target setpoint, or new range) including an updated value or updated range for at least one selected controlled process variable. The selected controlled process variable may be referred to as a primary process variable or a key process variable. A projected updated operating point means simulating a new operating point/set point in which operator is interested in for obtaining a better performing operating point using the identified process model. The simulation generates a future risk profile and future profit profile for the selected controlled process variable(s). When the process model is a MIMO model, simulating for one variable (for an optimal operating point) can simulate the profit and limit violation events for its corresponding interacting variables.

Step 203 comprises generating risk/profit profile information for the selected controlled process variable, where the risk/profit profile information combines information from the future risk profile together with information from the future profit profile into at least one of a combined text, numeric, and graphical representation which includes an alarm limit for the selected controlled process variable. The alarm limit represented in a graphical display provides a helpful context for profit/risk balancing.

Conventional process plant control systems provide a visual display (e.g. on a plurality of display monitors) for operators that can be customized to show text, numeric and graphical information, so a wide variety of different summary representations of disclosed risk profile with the profit profile representations are generally possible. The displays and the sub-elements of displays can be customized to suit the specific needs of a customer. In one specific example, a user interface design represents the risk/profit profile using a small graphical icon with moving elements and color changes to indicate profit, risk and any significant changes in status of the parameter.

The risk/profit profile information may be initially displayed in a summary form (e.g., in main operating graphics), wherein the summary form visualization generally includes some values as well as graphical representations and can include a link (e.g., a hyperlink) which when selected displays a detailed graphical view of the risk/profit profile information which includes more information as compared to the summary form. For example, FIG. 4 described below is a specific example of a detailed representation for the risk/profit profile information including a detailed graphical view including an alarm limit for the selected controlled process variable.

For most process variables, as the profit increases, so does the risk. Disclosed risk/profit profile information provides operators sufficient information on how close or far to operate (set operating conditions) from the optimal operating point (which maximizes profit) such that the profit is increased while the risk associated with the new operating conditions it not increased to a point where the alarm limits would be significantly more often reached. This simulation helps in better understanding of the profit and risk profile for the targeted operating point. The risk and profitability can thus be used together to find a trade-off between risk and profit which in turn helps one to make a qualitative or quantitative decision on the new operating point.

The balance point between operating risk and profitability can be automatically recommended by disclosed algorithms based on the risk and profitability profile (risk/profitability vs. operating point). The starting point (criteria) for this can be the historical balance point observed in past safe and profitable operation of the process. However, the process plant operator can ultimately retain the responsibility to accept or override the final choice of the target operating point.

Operators can be guided by visualization of the risk profile and profitability profile and historical trends of such (see FIG. 4 described below). For example, if the risk profile and profit profile for a selected process variable is quantified using a scale of 0 to 100, where in 0 means minimum risk or profit and 100 means maximum risk or profit, a balance point can be obtained by defining appropriate predetermined thresholds for the balance point. For example, for a particular process variable if the profit associated with it is greater than 80, and the risk is less than 20, this can be used as the balance point, and that particular operating point selected as being appropriate. A risk profile and profit profile is generally applicable for all primary (or key) process variables, which as described generally represents only a small percentage (less than 10%, such as 10 to 20) of 150 to 400 process variables monitored that are selected as primary variables.

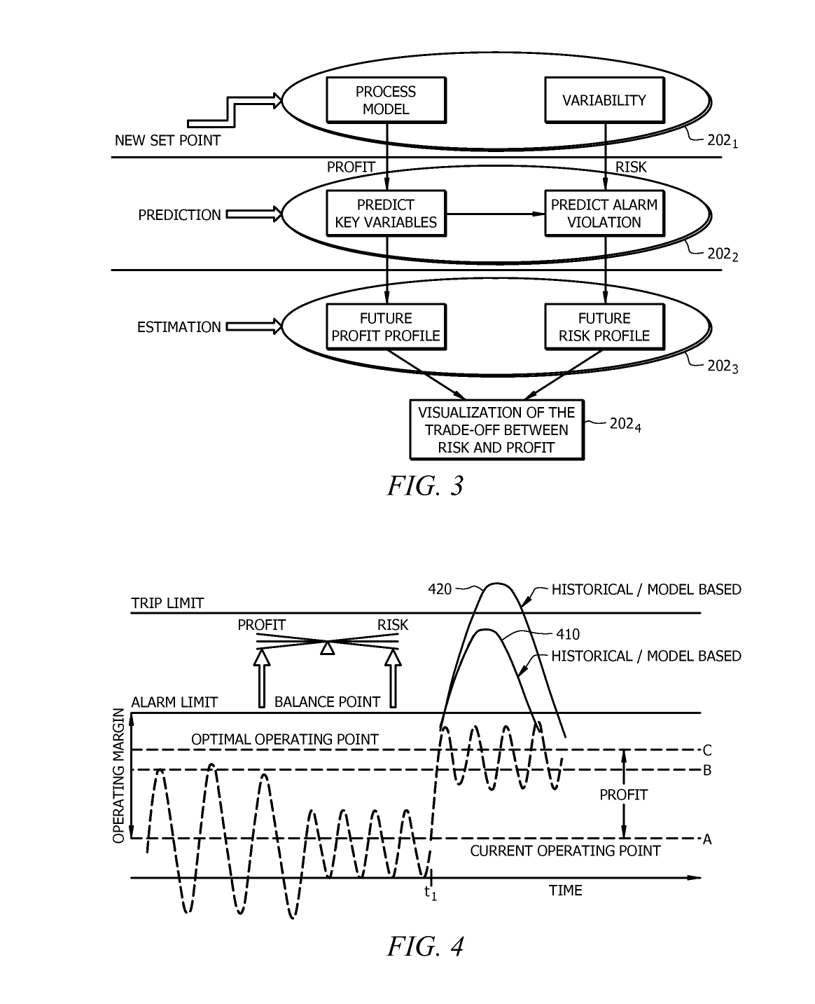

FIG. 3 is a schematic representation of the flow of an example method of controlling physical processes including integrating a future risk profile together with a future profit profile to help determine a new operating point, providing further details for the simulating step 202 of method 200 including separate tracking of the profit and risk data processing flows. Step 202₁ is shown as (an operator) inputting an updated set point shown as a “new set point” to the process model generated in step 201, where a process model is generated that includes a variability (noise) measure for at least one selected controlled process variable.

Step 202₂ comprises the output of the simulation of the process model at the new set point being a predicted distribution of the selected process variable(s) and the variability from the model providing predicted alarm violations for the selected process variable(s). Step 202₃ comprises using the predicted distribution of selected process variable together with predetermined alarm limits (generally set by an off-line engineering work process that estimates the risk to process safety, environmental release and equipment damage) to estimate a future profit profile, and using the predicted alarm violations for the selected process variable to estimate future risk assessment expressed as future risk profiles for the respective selected process variable.

The future profit profile is shown combined with the future risk profile in step 202₄ shown as a visualization of the trade-off between risk and profit which enables step 203 described above for each of the selected controlled process variable(s) to allow operator visualization. This visualization allows the risk and profitability to be used together to find a trade-off between risk and profit which in turn helps an operator make a qualitative or quantitative decision on the new operating point. The risk profile and profitability profile can be described to the operator (e.g., visualized in a display) both in a qualitative way including numerical values (e.g. $profit/hr and probability of reaching a trip limit) typically in a graphical display, or qualitatively (high, low, medium), such as in a text form.

The selected controlled process variable generally comprises a plurality of controlled process variables, where the generating risk/profit profile information involves separately generating risk/profit profile information for the first controlled process variable and the second controlled process variable. As noted above, the process model can be generated at least in part by historical operating data from the physical process run by the processing plant. The process model can also be generated using a system identification tool or a control performance monitoring tool.

The method can be implemented offline, and the method can include generating recommended target upper and lower operating bounds for the selected controlled process variable based on the alarm limit for the first controlled process variable and the second controlled process variable, the process model and historical operating data from the physical process run by the processing plant. The method can also be implemented on-line (real-time), with the method further including generating recommended target upper and lower operating bounds for the selected controlled process variable based on the historical operating data for physical process together with current measured values for controlled process variables and optionally also other on-line measurements, such as feed quality and other operating conditions.

The method can quantify a risk value and a profit value at the updated operating point. In one embodiment, the method further comprises automatically recommending a balance point for the selected controlled process variable, where the balance point corresponds to a particular value for the selected controlled process variable, or values for the each of the selected (key) process variables.

FIG. 4 is a graphical plot of the value of an example process variable (y axis) vs. time (x-axis) showing a current operating point (A) and a new operating point (B) including the simultaneous display of a risk profile (alarm limit and trip limit both shown) together with a profit profile to assist an operator to determine a new (future, or updated) operating point, according to an example embodiment. The interaction between a plurality of the process variables is taken care by the process model, though FIG. 4 for simplicity shows only one process variable. As noted above, for a typical processing unit there may be 10 to 20 selected primary (or key) safety, environmental or equipment health related process variables that would be associated with high priority alarms and trips, so generally the operator will be managing a set of operating points associated with each of these selected process variables. Although the operating point for each variable is generally managed independently to find a tradeoff between risk and profitability, the interaction between various variables is included in the simulation of the risk profile.

The excursions of the process variable shown in FIG. 4 are potential excursions trajectories 410 and 420 of the process variable resulting from a proposed operating point change at t₁ from operating point A to operating point B that could result based on past observation of historical (stored) process data, a dynamic process model and the current plant state. A deviation above the alarm limit and its duration in the alarm state (above the alarm limit) is a measure of the process risk. A “trip limit” is associated with a safety instrumented system (SIS) that would cause the process unit to be shut down safely, but at some economic cost to the operating company (in terms of lost production).

The two predicted excursions 410 and 420 following t₁ shown in FIG. 4 illustrate different cases, where for excursion 410 the process control system is predicted to be better able to mitigate for a typical process disturbance (to the new operating point B) in a more timely way, ensuring that the alarm limit threshold shown is crossed for a relatively short period of time and the trip limit is not crossed. An operator can decide to implement the proposed operating point change at t₁. In the second instance, excursion 420, the control system is predicted to be not as capable of mitigating for a typical process disturbance to the new operating point B in timely way, so that a higher amplitude excursion results in the alarm limit threshold being crossed as well as the trip limit. Based on excursion 420, an operator would reject the proposed operating point change at t₁.

In terms of managing the operating point, the process operator will typically specify a target value (or setpoint) or narrow range (high and low bound) for the automatically controlled (primary) variables. Many of these controlled variables will be managed independently. Often supervisory control computer software will adjust multiple valves in a coordinated way to achieve higher level control objectives, but again the setpoint or ranges specified to the supervisory control will be specified on an individual basis.

While all process variables generally have a sensible operating range, hazardous conditions are typically defined by a high or low bound, thus being asymmetric. So for example, a tube carrying oil through a furnace heater will have an upper bound on the temperature it can be operated at. Above this metallurgical temperature limit determined by primarily by the metal composition, the tube metal will soften, and could thin and potentially rupture with hazardous consequences. Under normal circumstances there is no safety risk of reducing the temperature down to ambient conditions for the tube carrying oil, and hence there would be no low temperature alarm or trip limit.

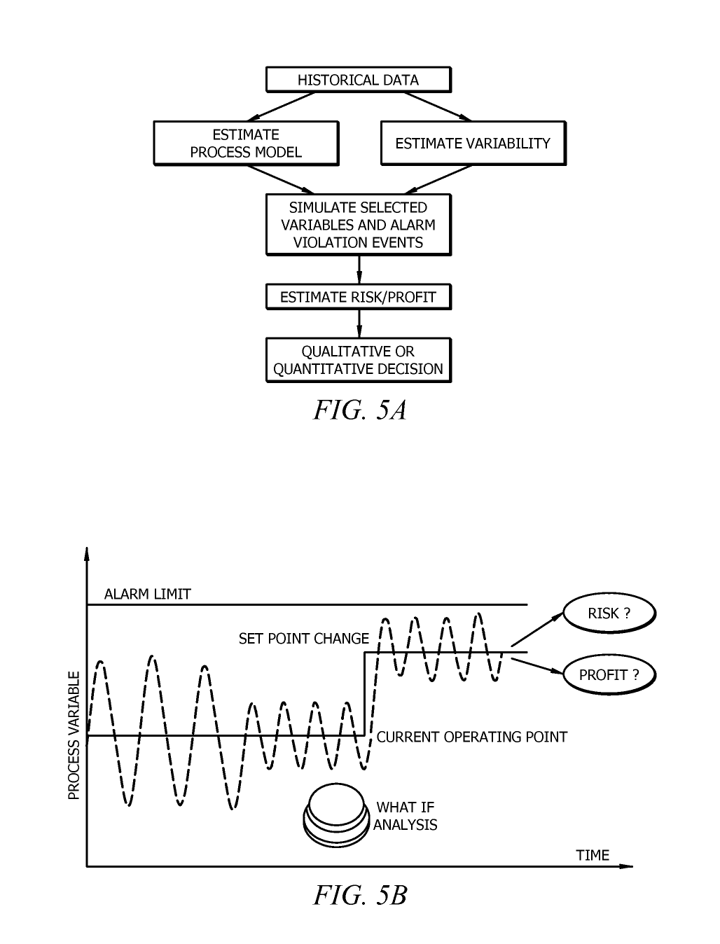

Disclosed methods can be implemented as an offline or an online tool. As an off-line tool, recommended target upper and lower operating bounds are generated for key operating variables, based on the alarm limits, the process model, and historical operating data. Embodied as an offline tool, various operating points can be simulated using process model to predict selected (e.g., key) variable dynamics and alarm violation events as depicted in the flow shown in FIG. 5A. As described above, the process model can be obtained by projecting (simulating) the current operating point on historical plant data. Commercially available control performance monitoring (a Honeywell International-CPM product) and system identification (e.g., MATLAB SYSID TOOL BOX) tools can be used to provide an estimated model of the process and an estimate of the variability of the process parameters.

Once the process model is identified, dynamics of the various selected variables can be simulated based on the estimated variability, and future profitability can be evaluated. The process model can also be used to simulate various alarm violation events given predetermined alarm limits. Once the alarm violation events are simulated, future risk for the process can be evaluated using data processing including abnormal event tracking, set theoretic formulation, and Bayesian analysis. The risk profile and profit profile can be simultaneously displayed for one or more future proposed (updated) operating points as risk/profit profile information in a text numeric, and/or graphical representation, and using the representation an operator can identify a trade-off between risk and profit to select a new operating point that push the operating point closer to the operating point then possible using conventional tools which provides higher possible profit.

As an online tool, an operator perform a “what if analysis” for a proposed updated operating point by estimating the risk and profit associated with a desired operating point change, and then making a decision on the targeted operating point by employing a trade-off between risk and profitability as depicted for a single process variable shown in FIG. 5B. The risk profile and profit profile are simultaneously displayed for the new proposed (updated) operating point, and the operator can make a decision based on a trade-off between risk and profit whether (or not) to select the new operating point allowing the new operating to be closer to the operating point which provides the highest possible profit.

Disclosed embodiments can be applied to generally to the process industry which run physical processes, wherein operator skill is a key aspect of operational asset. Disclosed embodiments will help reduce the dependency on operator skill needed to operate the plant closer to the optimal operating point by providing a directional or monetized trade-off between risk and profitability for the current operating point or new updated operating point(s) targeted by an operator.

### EXAMPLES

Disclosed embodiments are further illustrated by the following specific Examples, which should not be construed as limiting the scope or content of this Disclosure in any way.

As described above, disclosed algorithms balance the profit and risk of a manufacturing (physical) process to help determine how close operators should operate process primary (or key) variables relative to their respective alarm limits. Since there are generally multiple primary process variables and thus multiple alarm limits for manufacturing processes, the operating envelope is multidimensional.

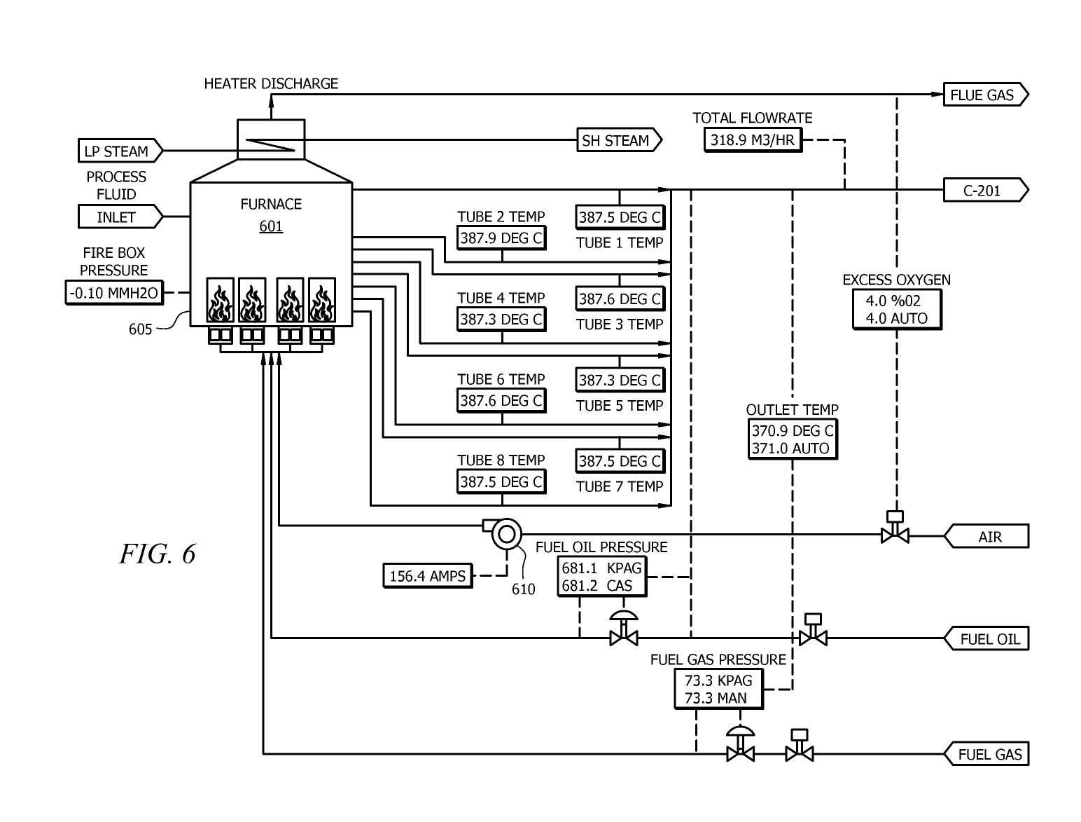

Consider a fired heater in a chemical processing plant or a crude oil refinery. FIG. 6 is a depiction of an example MIMO fired heater (or furnace) 601 along with its associated inputs and outputs upon which this Example is based. The parametric values (e.g., temperature, pressure and flow rate) shown in FIG. 6 are illustrative only. The process fluid (mineral oil or chemical feedstock) is shown split into 8 parallel flows that then enters as inputs into the fired heater 601 in 8 separate metal tubes. In the fired heater 601, the tubes are initially heated by the combustion gas (in the upper section of the fired heater 601) and then pass directly over the fuel burners (in the firebox) before recombining into a single stream externally to the furnace firebox. The heated process fluid then passes on to the next stage of processing to C-201, such as a fractional distillation column or a chemical reactor.

The objective of the process model employed is to define the relationship between the operating point variables set (including primary variables) by the operator (and/or the supervisory control) and the alarmed variables. In the first instance, this helps to simulate the relationship between the operating point variables with economic importance (e.g. feed and outlet temperature) and the level/value of the variables associated with operating risk. There is a need for a multivariate model recognized because of the requirement to understand which of the alarmed variables will approach their limits first (most constraining) as the economically important variables are moved in a more profitable direction. Secondly, there is a need to characterize how effectively a deviation (or excursion) in an alarmed variable can be mitigated (dynamically controlled) by the control system. A variable that is slower to respond or more difficult to control will require a greater safety margin between its normal operating point and the alarm limit.

The control system will automatically adjust a number of selected controlled process variables (key variables) to maintain the safe and efficient operation of the fired heater 601. Specifically:
1. The fuel oil pressure at the burner inlet (which has a direct effect on the amount of fuel burnt and hence firing duty);
2. The fuel gas pressure at the burner inlet (separate set of burners)
3. The air flow to the firebox to ensure sufficiently safe, but not too much excess of air.
4. The flow control valve adjusting the total amount of process fluid through the furnace and downstream into C-201.

By adjusting these four (4) selected (or primary) process variables, the control system will be able to regulate to targets (setpoints) the temperature of the fluid leaving the fired heater 601, the amount of excess oxygen in the flue gas, and the total flow of process fluid being heated.

A number of auxiliary variables will also be monitored by the process operator using the control system to ensure safe operation and prevent damage to the plant's equipment. These include:
1. The temperatures of the tubes containing the process fluid at various points along their length on their outer surface (skin). This is to ensure that the tubes are not exposed to too high a temperature which may permanently damage the tubes and in the worst case lead to a rupture and spillage of flammable oil into the firebox;
2. The pressure in the fire box 605. This should be below atmospheric such that there is a leakage of ambient temperature air into the firebox, not a leakage of corrosive hot combustion gases through the firebox walls.
3. The amps to the air blower motor 610, to ensure it does not overheat and burn-out.

To help the operator become aware of any operational problems, operators can be alerted with an audible and visual warning (alarm) when any of the key monitored variables deviate sufficiently above or below normal bounds (alarm limit/point). For example, the tube skin temperatures may have alarm limit set for temperatures above 700° C.

Note that some or all of the auxiliary variables may also be monitored by a supervisory control application, which in turn will adjust the targets for the selected (key) controlled variables, such as the auxiliary variables process fluid feedrate and exit temperature. There will also be a safety instrumented system that will monitor critical variables and automatically shutdown the equipment (trip), e.g. cut off fuel, when the variables exceed the alarm limit point by a certain margin (e.g. 750° C. for the skin temperatures).

From an economic standpoint there is typically an incentive to maximize the production rate (flow of process fluid). As the operator increases the feedrate of process fluid, the control system will cause more fuel to be fired to ensure that the outlet temperature is maintained. However, this will mean that the heater tubes will get hotter, more amps will be consumed by the air blower motor and the firebox pressure (draft) will more closely approach atmospheric pressure.

In this simple example, there may also be an economic incentive to increase the outlet temperature of fluid to unit C-201 to increase reaction rate or separation effectiveness. This will have a very similar effect on the constraints as an increase in feedrate.

The economic value or profitability of the process can therefore be directly related to the process fluid feedrate and the process fluid exit temperature (e.g. in $/hr or in a normalized version of this, e.g. a scale of 0-100). These are key operating point variables set/adjusted by the operators.

The risk to the operating plant is evaluated from the variables that are operator monitored or directly controlled by the control system. The controlled variables in this Example (e.g. the process fluid exit temperature, excess oxygen in the flue gas and the total flow) cannot be perfectly controlled because of the influence of external disturbances, e.g. the weather, changes in process fluid composition, changes in fuel calorific value.

Similarly the monitored auxiliary variables are also influenced by the same/similar disturbances in addition to the effects of the adjustments that the control system makes. These disturbances cause process variable variability or noise.

As the variables deviate further from their alarm limits (in the wrong direction) the probability of equipment damage, safety instrument system trip (which means economic loss in terms of production) or a hazardous event increases. The risk is generally assessed from prior incidents and “near misses” from historical data.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

1. A method for controlling physical processes, comprising:
providing a process model for a physical process run by a processing plant including a plurality of controlled process variables, said process model representing an interaction between said plurality of controlled process variables and providing a variability measure for at least a portion of said plurality of controlled process variables;
using said process model with software run on a computing device, simulating an updated operating point including an updated value or updated range for at least one selected controlled process variable from said portion of said plurality of controlled process variables, said simulating generating a future risk profile and a future profit profile for said selected controlled process variable, and
generating risk/profit profile information for said selected controlled process variable, said risk/profit profile information combining information from said future risk profile together with information from said future profit profile into at least one of a combined text, numeric, and graphical representation which includes an alarm limit for said selected controlled process variable.

2. The method of claim 1, wherein said risk/profit profile information is displayed in a summary form on a display utilized by said computing device, wherein said summary form includes a link which when selected displays a graphical view of said risk/profit profile information on said display including more detail as compared to said summary form.

3. The method of claim 1, wherein said at least one selected controlled process variable comprises a first controlled process variable and at least a second controlled process variable, wherein said generating risk/profit profile information involves separately displaying said risk/profit profile information for said first controlled process variable and said second controlled process variable on a display utilized by said computing device.

4. The method of claim 3, wherein said process model is generated at least in part by historical operating data from said physical process run by said processing plant.

5. The method of claim 1, further comprising generating said process model using a system identification tool or a control performance monitoring tool.

6. The method of claim 4, wherein said method is implemented offline, and said method further includes generating recommended target upper and lower operating bounds for said selected controlled process variable based on said alarm limit for said first controlled process variable and said second controlled process variable, wherein said process model and said historical operating data are from said physical process run by said processing plant.

7. The method of claim 4, wherein said method is implemented on-line, and said method further includes generating recommended target upper and lower operating bounds for said selected controlled process variable based on said historical operating data for said physical process together with current measured values for said portion of said plurality of controlled process variables.

8. The method of claim 1, further comprises quantifying a risk value and a profit value at said updated operating point.

9. The method of claim 1, further comprising automatically recommending a balance point for said selected controlled process variable.

10. A computer program product, comprising:
executable code transportable by a non-transitory machine readable medium, wherein execution of said code by at least one programmable computing device causes said computing device to perform a sequence of steps for controlling a physical process run by a processing plant with a process model including a plurality of controlled process variables, said process model representing an interaction between said plurality of controlled process variables and providing a variability measure for at least a portion of said plurality of controlled process variables;
said sequence of steps comprising:
simulating an updated operating point including an updated value or updated range for at least one selected controlled process variable from said portion of said plurality of controlled process variables, said simulating generating a future risk profile including an alarm limit and future profit profile for said selected controlled process variable, and
generating risk/profit profile information for said selected controlled process variable, said risk/profit profile information combining information from said future risk profile together with information from said future profit profile into at least one of a combined text, numeric, and graphical representation which includes said alarm limit for said selected controlled process variable.

11. The computer program product of claim 10, wherein said risk/profit profile information is displayed in a summary form on a display utilized by said computing device, wherein said summary form includes a link which when selected displays a graphical view of said risk/profit profile information including more detail as compared to said summary form.

12. The computer program product of claim 10, wherein said at least one selected controlled process variable comprises a first controlled process variable and at least a second controlled process variable, wherein said generating risk/profit profile information involves separately displaying said risk/profit profile information for said first controlled process variable and said second controlled process variable on a display utilized by said computing device.

13. The computer program product of claim 12, wherein said process model is generated at least in part by historical operating data from said physical process run by said processing plant.

14. The computer program product of claim 10, wherein said sequence of steps further comprises generating said process model using a system identification tool or a control performance monitoring tool.

15. The computer program product of claim 13, wherein said sequence of steps is implemented offline, said sequence of steps further including generating recommended target upper and lower operating bounds for said selected controlled process variable based on said alarm limit for said first controlled process variable and said second controlled process variable, said process model and said historical operating data from said physical process run by said processing plant.

16. The computer program product of claim 13, wherein said sequence of steps is implemented on-line, and wherein said sequence of steps is implemented further including generating recommended target upper and lower operating bounds for said selected controlled process variable based on said historical operating data for said physical process together with current measured values for said portion of said plurality of controlled process variables.

17. The computer program product of claim 10, wherein said sequence of steps further comprises quantifying a risk value and a profit value at said updated operating point.

18. The computer program product of claim 12, wherein said sequence of steps further comprises automatically recommending a balance point for said selected controlled process variable.
